(19) United States
(12) Patent Application Publication
(10) Pub. No.: US 2003/0012122 A1
(43) Pub. Date: Jan. 16, 2003

(54) Structure of a loading tray for the main shaft of a motor

(76) Inventor: Ching-Yuan Juan, Taipei City (TW)

Correspondence Address: JUAN, Ching-Yuan, PO Box 82-144, TAIPEI, TW

(21) Appl. No.: 09/904,539

(22) Filed: Jul. 16, 2001

(51) Int. Cl. G11B 23/00; G11B 25/00

(52) U.S. Cl. 369/271

(57) ABSTRACT

An improved structure of a loading tray for the main shaft of a motor which includes an enhancing structure for the loading tray, an anti-skidding cloth forming and combining structure, and a disc-urging device, characterized in that the enhancing device is provided with a tray support obtained from plastic molding to connect with a tray seat, and the tray support is located in a loading tray mold and is twice molded (by injection molding) and is covered by and combined with the loading tray as one unit so as to enhance the loading tray. The disc-urging device has a plurality of steel ball holes and the installation chambers thereof on the tray support or the protruded circumferential edge of the center of the loading tray, the installation chamber is provided with stainless steel balls, elastic plates, rubber blocks and a packing seat, wherein the elastic plate or the rubber block elastically compress the steel ball so that the ball surface of the steel ball protrudes out of the steel ball holes to urge the loading disc to prevent skidding when the loading disc rotates.

### BACKGROUND OF THE INVENTION

(a) Field of the Invention

The present invention relates to an improved structure of a loading tray for the main shaft of a motor, and in particular, to a loading tray structure having a loading tray body enhancing structure, an anti-skidding cloth-forming and combining structure and a disc-urging device which stabilizes the rotating of the loading disc. The present invention provides stability when the loading tray rotates and the performance of the loading tray is upgraded, and the loading tray structure avoids the sliding of a loaded disc.

(b) Description of the Prior Art

Recently, loading trays used in the main shaft of a motor used in CD, DVD are made from copper plate, and a center shaft is mounted together with a tray seat. Due to the high cost of the material and the fabrication procedures, plastic molding process is employed to overcome the above problems, but the shrinkage rate of the plastic material, the degree of deformation of the material, and the sloping difference of the tray face and the degree of swinging of the tray face are as high as 0.1 mm (which is known as 10 stripes). This drawback causes the structure to be not practical.

Further, when a CD, DVD is to be placed onto the loading tray, a layer of anti-skid cloth is first placed onto the loading tray. Such a step is a waste of time, and the cost of production is high, and further the adhesion force will loss and the function of anti-skidding is diminished. Other method that may be employed is by using a magnet for mounting or other mounting method. However, these methods of preventing sliding of the loaded disc are not ideal.

### SUMMARY OF THE INVENTION

Accordingly, it is an object of the present invention to provide an improved structure of a loading tray for the main shaft of a motor which mitigates the drawbacks of that fabricated by using copper plate material, where the cost of production is high and the poor quality products obtained by means of plastic molding method.

Another object of the present invention is to provide an improved structure of a loading tray for the main shaft of a motor which is used to prevent the sliding of the loaded disc.

An aspect of the present invention is to provide an improved structure of a loading tray structure for the main shaft of a motor comprising an enhancing structure for the loading tray, an anti-skidding cloth forming and combining structure, and a disc-urging device, characterized in that the enhancing device is provided with a tray support obtained from plastic molding to connect with a tray seat, and the tray support is located within a loading tray mold and is twice molded (by injection molding) and is covered by and combined with the loading tray as one unit so as to enhance the loading tray.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the enhancing structure of the loading tray of the present invention.

FIG. 2 is a sectional view of the enhancing structure of the loading tray of the present invention.

FIG. 3 is a perspective view of the tray support of the loading tray of the present invention.

FIG. 4 is a schematic view of the anti-skidding cloth forming and combining structure in accordance with the present invention.

FIG. 5 is a sectional view of the anti-skidding cloth forming and combining structure in accordance with the present invention.

FIG. 6 is a perspective view of the disc-urging device of the present invention.

FIG. 7 is a cross-sectional view of the disc-urging device of the present invention.

FIG. 8 is a perspective exploded view showing the tray support and the disc-urging device of the present invention.

FIG. 9 is a schematic view of a second preferred embodiment of the disc-urging device of the present invention.

### DETAILED DESCRIPTION OF THE PRESENT INVENTION

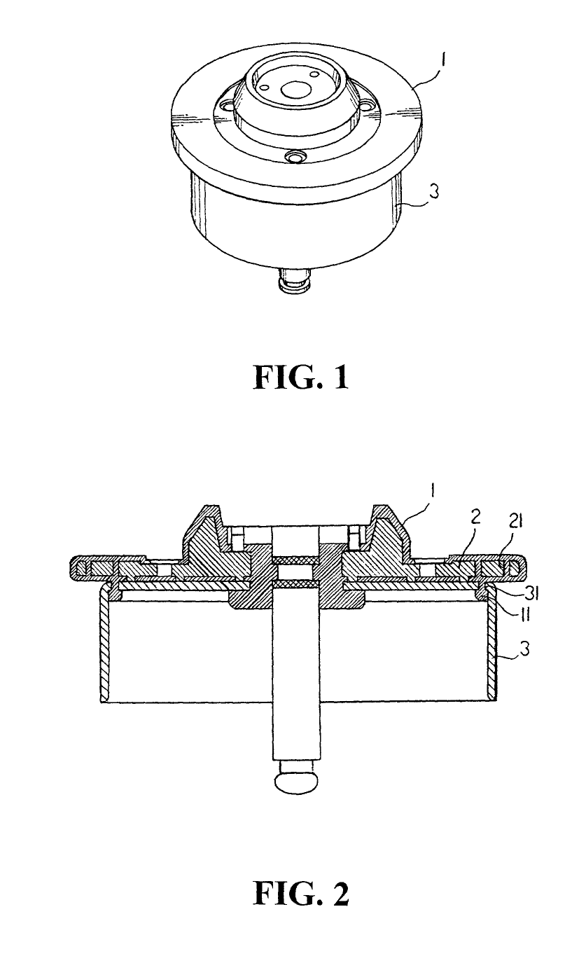

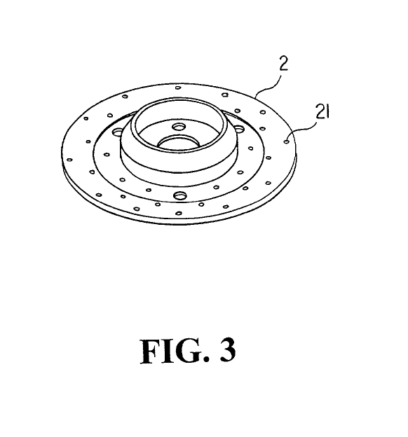

Referring to FIG. 1, there is shown the enhancing structure of the loading tray of the present invention. The loading tray 1 of the main shaft of a motor includes a tray support 2 and the tray support 2 is combined with a tray seat 3 by means of plastics molding within a mold. After releasing from the mold, the tray support 2 is placed into a loading tray mold for a second time molding process such that the tray support 2 is covered by and combined with the loading tray 1 as one unit to enhance the loading tray 1 so that the rate of plastic shrinkage, the degree of deformation of plastic and the sloping difference of the tray surface and the degree of vibration of the tray surface can be lowered to about 0.1 mm, which is within the scope of requirements. This will enhance the stability of rotation of the loading tray loaded with CD or DVD. The application effectiveness of the loading tray is thus enhanced.

A plurality of engaging holes 31 are provided on the tray seat 3 such that during the second time molding of the loading tray 1 within the mold, the ejected materials pass through the engaging holes 31 to the bottom thereof to form into an engaging head 11 so that the loading tray 1, after it is covered and combined with the tray support 2, it is enhanced and in engagement with the tray seat 3.

In the preferred embodiment, the tray support 2 is provided with a plurality of distribution holes 21 such that during the ejection molding procedure, the material for the molding of the loading tray 1 can engage with the distribution holes 21 to enhance the effect of combination.

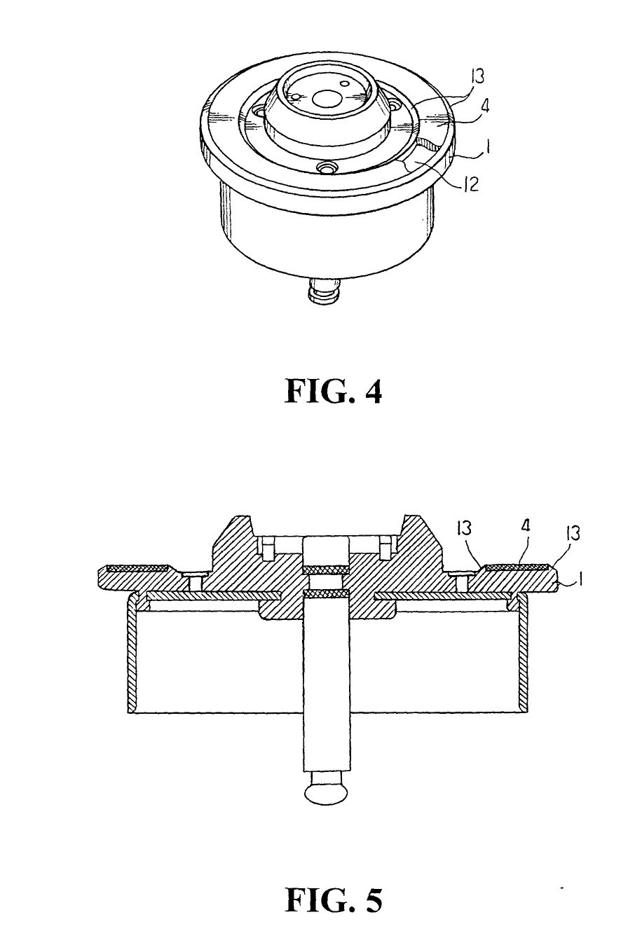

FIGS. 4 and 5 show the anti-skidding cloth forming and combining structure of the present invention. The surface of the loading tray 1 is provided with a concentric circular recess 12 and an aqueous resin or synthetic compound is inserted into the recess 12 to form the anti-skidding cloth 4 when it is cured. After the resin or the synthetic compound is cured, it is adhered to the loading tray 1 to form as a unit. The recess 12 can be fully filled with the aqueous resin or synthetic compound such that the loading tray 1 can rotate stably with a very small vibration of 0.005 mm loaded with CD or DVD. In accordance with the present invention, the functions of anti-skidding and horizontal stabilizing are obtained and therefore, the present structure minimizes production cost and saves time in the fabrication procedures.

In the preferred embodiment, the edge of the circular recess 12 is provided with an inverted corner 13 so that the aqueous resin fully filled the recess 12 forms into the anti-skidding cloth when it is cured, the horizontal and anti-skidding function will not be interrupted by the circumferential edge of the recess 12. That is, the horizontal and anti-skidding function of the loading tray 1 is significant.

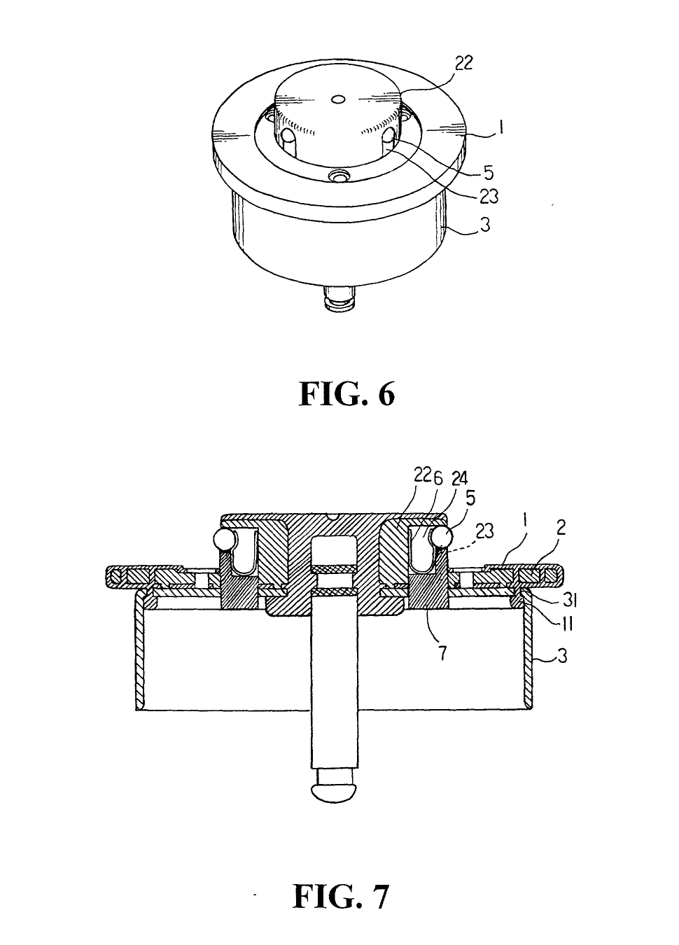

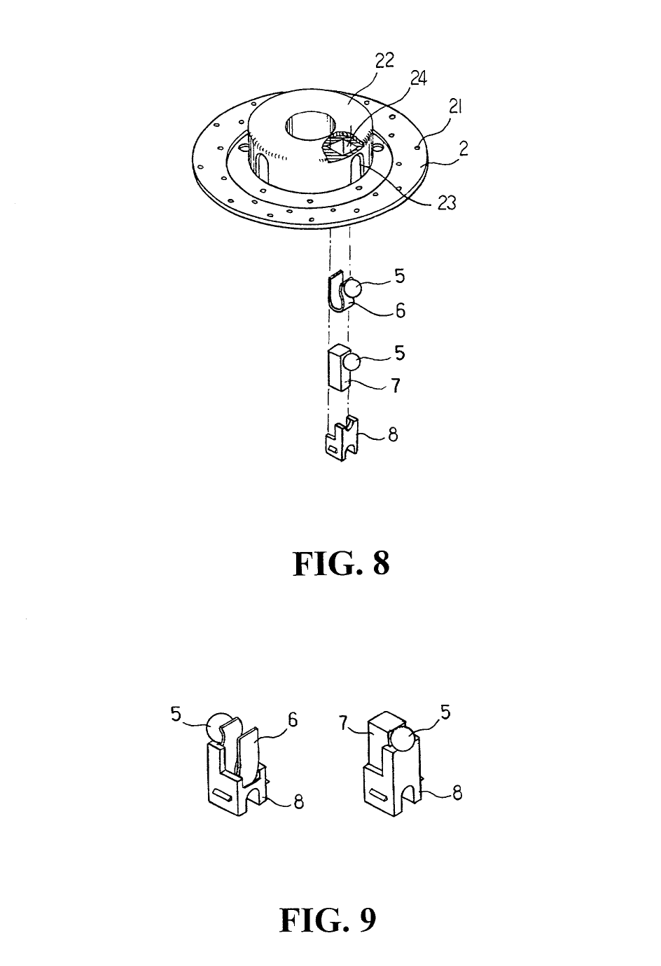

FIGS. 6, 7, 8 and 9 show the disc-urging device of the present invention. The circumferential edge at the center protruded section 22 of the tray support 2 is provided with three equidistant, distributed steel ball holes 23, having three corresponding installation chambers 24 for the holding of stainless steel balls 5, U-shaped elastic plate 6, or low and high temperature resistant rubber block 7 and a packing seat 8. The steel ball 5 is mounted on the top end, external side of the rubber block 7 or the U-shaped elastic plate 6. The U-shaped elastic plate 6 or the rubber block 7 is mounted within the installation chambers 24, such that the steel balls 4 are located in the position of the steel ball hole 23 and is urged by the packing seat 8 and is mounted at the bottom of the installation chambers 24. The U-shaped elastic plate 6 or the rubber block 7 compress the steel ball 5 such that the balls surface of the steel ball 5 is partially protruded the steel ball hole 23 to tightly urge the loaded disc, preventing the loaded disc from skidding while rotating.

In the preferred embodiment, the steel ball holes 23 and the installation chambers 24 can be formed on the loading tray 1 if there is no tray support 2.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An improved structure of a loading tray structure for the main shaft of a motor comprising an enhancing structure for the loading tray, an anti-skidding cloth forming and combining structure, and a disc-urging device, characterized in that the enhancing device is provided with a tray support obtained from plastic molding to connect with a tray seat, and the tray support is located in a loading tray mold and is twice molded (by injection molding) and is covered by and combined with the loading tray as one unit so as to enhance the loading tray.

2. The improved structure of a loading tray of claim 1, wherein the anti-skidding cloth forming and combining structure is positioned in a concentric circular recess on the surface of the loading tray, the recess is provided with anti-skidding cloth obtained from the curing of aqueous resins or synthetic compounds, the anti-skidding stabilizes the rotating of the loading tray and is formed into a unit with the loading tray after it is cured.

3. The improved structure of a loading tray of claim 1, wherein the disc-urging device has a plurality of steel ball holes and the installation chambers thereof on the tray support or the protruded circumferential edge of the center of the loading tray, and the installation chamber is provided with stainless steel balls, elastic plates, rubber blocks and a packing seat, wherein the elastic plate or the rubber block elastically compress the steel ball so that the ball surface of the steel ball protrudes out of the steel ball holes to urge the loading disc to prevent skidding when the loaded disc rotates.

4. The improved structure of a loading tray of claim 1, wherein the surface of the tray seat is provided with a plurality of engaging holes for ejection material to pass through to form an engaging head at the bottom thereof so as to enhance the engagement of the loading tray with the tray seat.

5. The improved structure of a loading tray of claim 1, wherein the tray support is provided with a plurality of distribution holes allowing the engagement of the loading tray and the tray support during the molding process.

6. The improved structure of a loading tray of claim 2, wherein the edge of the circular recess is provided with inverted corner to enhance the horizontal of the loading tray and the anti-skidding function of the loading tray.
